(19) United States
(12) Patent Application Publication
(10) Pub. No.: US 2025/0300889 A1
(43) Pub. Date: Sep. 25, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Eiji Nishi, Kanagawa (JP)

(73) Assignee: FUJIFILM Business Innovation Corp., Tokyo (JP)

(21) Appl. No.: 18/773,733

(22) Filed: Jul. 16, 2024

(30) Foreign Application Priority Data
Mar. 22, 2024 (JP) 2024-047160

(51) Int. Cl. H04L 41/0823

(52) U.S. Cl. CPC H04L 41/0836

(57) ABSTRACT

An information processing system includes a processor configured to determine whether or not to execute addition or change to a first apparatus, when making the addition or the change of a function used to communicate with a communication destination to the first apparatus, based on communication records between a second apparatus already provided with the function and the communication destination.

### Cross-Reference to Related Applications

This application is based on and claims priority under 35 USC 119 from Japanese Patent Application No. 2024-047160 filed Mar. 22, 2024.

### Background

### (i) Technical Field

The present disclosure relates to an information processing system, a non-transitory computer readable medium, and an information processing method.

### (ii) Related Art

Japanese Unexamined Patent Application Publication No. 2012-221152 discloses a management apparatus to manage update of firmware installed in an image forming apparatus. The image forming apparatus is coupled to a plurality of processing apparatuses and executes image forming processing based on a job from each of the plurality of processing apparatuses. The management apparatus includes a storage means to store update information required to update the firmware, an identifying means to identify an image forming function, which is frequently used in each of the plurality of processing apparatuses, of the image forming apparatus, a determining means to determine a possibility of occurrence of a problem in the image forming function in each of the plurality of processing apparatuses due to an update of the firmware by comparing an image forming function which is influenced by the update of the version of the firmware with an image forming function which is frequently used in each of the plurality of processing apparatuses, and a processing means to execute update processing of the firmware using the update information after execution of processing based on a determination result in the determining means.

Japanese Unexamined Patent Application Publication No. 2006-99393 discloses a firmware management apparatus to manage firmware of an electronic device in which current firmware being used is stored in a rewritable nonvolatile storage means. The firmware management apparatus includes a counting means to count the number of errors occurred when the current firmware is executed by the electronic device, a comparing means to compare the number of errors of the current firmware counted by the counting means with the number of errors occurred when firmware of a version used in the past is executed by the electronic device, an identifying means to identify firmware of a version more suitable for use than the current firmware among the firmware of versions used in the past, and a changing means to change the current firmware to the firmware of the version identified by the identifying means.

Japanese Unexamined Patent Application Publication No. 2008-269226 discloses an image forming apparatus capable of communicating with a server storing a plurality of types of update programs together with update information including an update state for each of a plurality of types of functions. The image forming apparatus includes a program storage means to store an execution program, a function execution means to execute the stored execution program and to execute at least one of the plurality of types of functions, a history storage means to store, for each executed function, history information relating to execution of the function when any one of the plurality of types of functions is executed, a determination means to determine a target program from the plurality of types of update programs stored in the server based on the history information and the update information stored in the server, and an update means to acquire the determined target program and update the execution program stored in the program storage means with the acquired target program.

### SUMMARY

Conceivable is an information processing system including a processor configured to determine whether or not to execute addition or change to an apparatus, when making the addition or the change of a function (for example, firmware and an application) used to communicate with a communication destination to the apparatus (for example, a multifunction apparatus), based on only information regarding a version of the function.

In the information processing system, in a case that the version of the added or changed function is not compatible with the apparatus, when the apparatus communicates with a communication destination using the function, a communication failure may occur in which the apparatus cannot communicate with the communication destination.

Aspects of non-limiting embodiments of the present disclosure relate to, when a processor makes addition or change of a function used to communicate with a communication destination to an apparatus, suppressing occurrence of a communication failure in a case that the apparatus communicates with the communication destination using the function compared to a case that the processor determines whether or not to execute the addition or the change to the apparatus based on only information regarding a version of the function.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to determine whether or not to execute addition or change to a first apparatus, when making the addition or the change of a function used to communicate with a communication destination to the first apparatus, based on communication records between a second apparatus already provided with the function and the communication destination.

### BRIEF DESCRIPTION OF THE DRAWINGS

Exemplary embodiments of the present disclosure will be described in detail based on the following figures, wherein:

FIG. 1 is a schematic diagram of an information processing system according to the present exemplary embodiment;

FIG. 2 is a block diagram of an example of a hardware configuration of a multifunction apparatus according to the present exemplary embodiment;

FIG. 3 is a table of an example of communication records of a plurality of multifunction apparatuses according to the present exemplary embodiment;

FIG. 4 is a block diagram of an example of a functional configuration of a control device in the multifunction apparatus according to the present exemplary embodiment;

FIG. 5 is a flowchart of an example of a flow of update processing executed in the information processing system according to the present exemplary embodiment;

FIG. 6 is a table of another example of the communication records illustrated in FIG. 3; and

FIG. 7 is a table of another example of the communication records illustrated in FIG. 3.

### DETAILED DESCRIPTION

Hereinafter, an example of an exemplary embodiment of the present disclosure will be described with reference to the drawings.

### Information Processing System 10

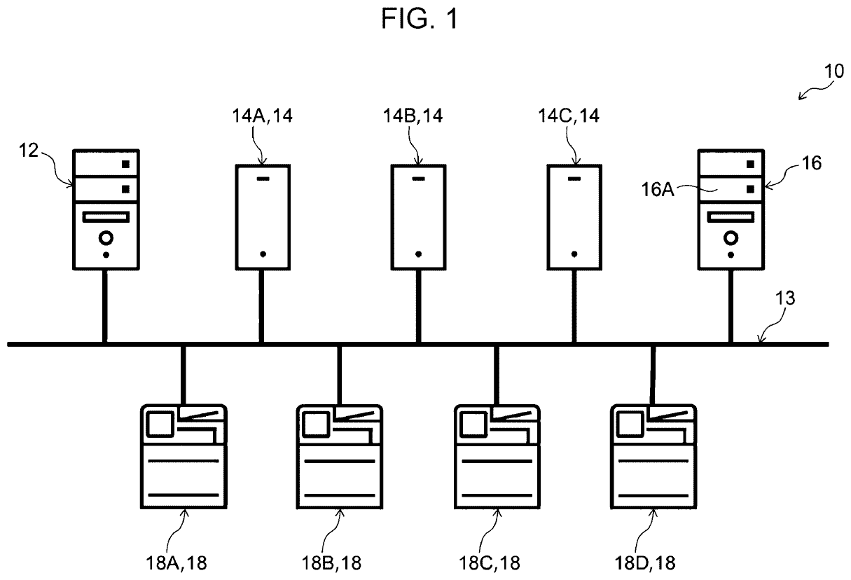

An information processing system 10 according to the present exemplary embodiment will be described. FIG. 1 is a schematic diagram of the information processing system 10 according to the present exemplary embodiment.

The information processing system 10 is a system that processes information. As illustrated in FIG. 1, the information processing system 10 includes a management server 12, a plurality of server apparatuses 14, a download server 16, and a plurality of multifunction apparatuses 18.

As illustrated in FIG. 1, the apparatuses in the information processing system 10 are coupled to each other with a communication network 13. The communication network 13 is, for example, a communication network using at least one of wired and wireless lines. Specifically, for example, various networks such as a local area network (LAN) and the Internet can be used as the communication network 13. Thus, the apparatuses in the information processing system 10 can communicate with each other.

In the present exemplary embodiment, the apparatuses in the information processing system 10 are provided within the same network (that is, within a region having a common communication environment), and are enabled to communicate with each other within the network.

The information processing system 10 is a system in which the apparatuses can communicate with each other, and therefore, may also be referred to as a communication system. Further, the information processing system 10 may also be referred to as an execution system since the apparatuses each execute various types of processing. Hereinafter, each apparatus in the information processing system 10 will be described.

### Download Server 16

The download server 16 is a server apparatus that stores various kinds of data to be downloaded by the multifunction apparatus 18 and the like. The download server 16 can communicate with the apparatuses including the plurality of multifunction apparatuses 18 through the communication network 13.

The download server 16 has a storage 16A for storing various kinds of data. In the present exemplary embodiment, the download server 16 stores firmware (hereinafter, abbreviated as FW) to be downloaded by each of the plurality of multifunction apparatuses 18 in the storage 16A. In a case that firmware of a new version has been stored, the download server 16 transmits, to each of the plurality of multifunction apparatuses 18, information indicating that the firmware of the new version has been stored.

The download server 16 is configured as an apparatus including a central processing unit (CPU), a read-only memory (ROM), a random access memory (RAM), and the storage 16A, same as a control device 20 described later.

### Management Server 12

The management server 12 is a server apparatus that manages each apparatus in the information processing system 10. The management server 12 is enabled to communicate with each of the apparatuses including the plurality of multifunction apparatuses 18 and the plurality of server apparatuses 14 through the communication network 13.

The management server 12 is configured as an apparatus including a CPU, a ROM, a RAM, and a storage, same as the control device 20 to be described later.

### Plurality of Server Apparatuses 14

Each of the plurality of server apparatuses 14 is an example of a communication destination (communication partner), and is enabled to communicate with the apparatuses including the plurality of multifunction apparatuses 18 through the communication network 13. Each of the plurality of server apparatuses 14 transmits and receives various kinds of data such as image data and log information to and from each of the plurality of multifunction apparatuses 18.

In the present exemplary embodiment, as illustrated in FIG. 1, the plurality of server apparatuses 14 include, for example, three server apparatuses 14A, 14B, and 14C. The number of server apparatuses 14 may be any number.

Each of the server apparatuses 14 is configured as an apparatus including a CPU, a ROM, a RAM, and a storage, same as the control device 20 to be described later.

### Plurality of Multifunction Apparatuses 18

Each of the plurality of multifunction apparatuses 18 is an apparatus to form an image, and is, for example, an execution apparatus capable of executing processing such as copying, printing, scanning, and facsimile.

In the present exemplary embodiment, as illustrated in FIG. 1, the plurality of multifunction apparatuses 18 include, for example, four multifunction apparatuses 18A, 18B, 18C, and 18D. Note that the plurality of multifunction apparatuses 18 may include two, three, four or more multifunction apparatuses.

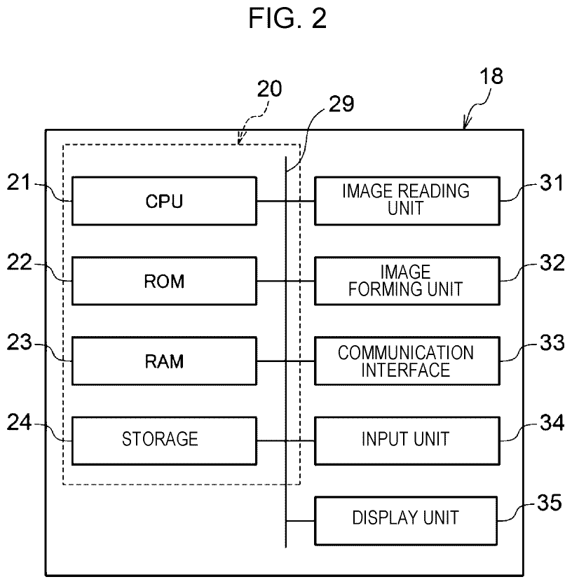

Specifically, as illustrated in FIG. 2, each of the plurality of multifunction apparatuses 18 includes the control device 20, an image reading unit 31, an image forming unit 32, a communication interface 33, an input unit 34, and a display unit 35.

The image reading unit 31 is a constituent (for example, scanner) that reads an image of a document. The image reading unit 31 generates image data by, for example, optically reading an image of a document and converting the image into a digital signal. Note that the image includes characters.

The image forming unit 32 is a constituent that forms an image on a recording medium such as a sheet. The image forming unit 32 forms an image on a recording medium by, for example, an electrophotographic method in which processes of charging, exposure, development, transfer, and fixing are performed. Note that the image forming unit 32 may form an image on a recording medium by any other method such as an ink jet method.

The communication interface 33 is a connection unit for communicating with other apparatuses (for example, the management server 12, the plurality of server apparatuses 14, and the download server 16). Specifically, the communication interface 33 communicates with other apparatuses through the communication network 13 using at least one of wired and wireless lines.

The input unit 34 is a constituent to which an instruction is input by a user. Specifically, the input unit 34 is constituted of, for example, an input key (for example, keyboard, operation button, or the like), a touch panel, and the like on which an input operation is performed by a user. The user's instruction includes an execution instruction to cause the multifunction apparatus 18 to execute executable processing. The processing includes, for example, copying, printing, scanning, and facsimile.

The display unit 35 is a notification unit that notifies a user of presentation information by displaying the presentation information to be presented to the user. The display unit 35 is configured of, as an example, a liquid crystal display or an organic electro luminescence (EL) display.

Note that the display unit 35 may function as the input unit 34. In the case above, the input unit 34 is configured of, as an example, a touch panel of a resistive film type, an electrostatic capacitance type, or the like, and an instruction by a user is input by a contact operation of the user.

The control device 20 is a device that controls each unit in the multifunction apparatus 18. The control device 20 has a function as a computer, and as illustrated in FIG. 2, includes a central processing unit (CPU) 21, a read only memory (ROM) 22, a random access memory (RAM) 23, and a storage 24. The CPU 21, the ROM 22, the RAM 23, and the storage 24 are coupled to each other by a bus 29.

The CPU 21 is a central processing unit that executes various types of programs including an information processing program and controls each unit. The CPU 21 is an example of a processor. The ROM 22 stores therein various types of programs including the information processing program and various pieces of data. The RAM 23 temporarily stores programs or data therein as a workspace.

The storage 24 is constituted of one or a plurality of storage media such as a hard disk drive (HDD), a solid state drive (SSD), or a flash memory, and stores various types of programs including an operating system. Note that the information processing program may be stored in the storage 24.

In the present exemplary embodiment, firmware as software, having a control function of various types of processing including communication processing to communicate with other apparatuses, is stored in the storage 24. The firmware can be subjected to changes such as update (that is, version up), version down, and the like.

The firmware is an example of a function used to communicate with the server apparatus 14 (an example of a communication destination).

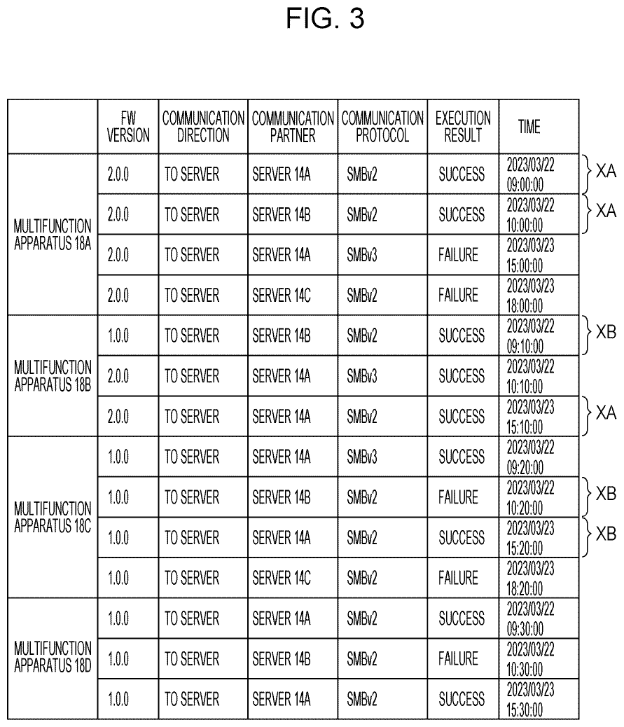

Further, the storage 24 can store various types of data including communication results. In the present exemplary embodiment, in a case that the multifunction apparatus 18 executes communication processing with another apparatus (for example, the server apparatus 14), a communication result is stored in the storage 24. As illustrated in FIG. 3, the communication result includes information indicating a version of its own FW at the time of communication, a communication direction, a communication partner, a communication protocol, an execution result, communication time, and the like. Every time the multifunction apparatus 18 executes communication with another apparatus, a communication result including these pieces of information is saved in the storage 24 as the communication records.

Note that in the communication direction, “To server” indicates the communication direction from the multifunction apparatus 18 to the server apparatus 14. In a case of the communication direction from the server apparatus 14 to the multifunction apparatus 18, “To multifunction apparatus” is set. Further, the storage location of the communication records of the plurality of multifunction apparatuses 18 is not limited to the own storage 24, and may be another location (for example, the management server 12).

In the control device 20, the CPU 21 reads out various types of programs including the information processing program from the ROM 22 or the storage 24, and executes the programs using the RAM 23 as a workspace. The CPU 21 realizes various types of functions by executing the information processing program.

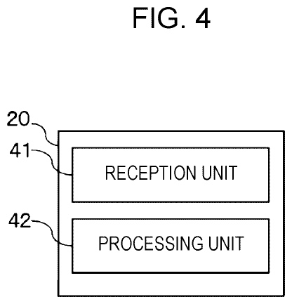

In the control device 20, as illustrated in FIG. 4, the CPU 21 functions as a reception unit 41 and a processing unit 42 by executing the information processing program.

The reception unit 41 receives, from the download server 16, storage information indicating that new FW has been stored, thereby acquiring the storage information. Further, the reception unit 41 acquires its own communication records and the communication records of the other multifunction apparatuses 18 (that is, the multifunction apparatuses 18A, 18B, and 18C).

The processing unit 42 executes determination processing to determine whether or not to execute addition or change to its own multifunction apparatus 18, when making the addition or the change of firmware used to communicate with the server apparatus 14 to its own multifunction apparatus 18, based on communication records between another multifunction apparatus 18 already provided with the firmware and the server apparatus 14. Specifically, the processing unit 42 executes update processing to be described later.

### Update Processing Flow According to Present Exemplary Embodiment

Next, an example of an update processing flow according to the present exemplary embodiment will be described. Here, an update processing flow when the multifunction apparatus 18D among the four multifunction apparatuses 18 updates the FW of an old version (hereinafter, referred to as old FW) to the FW of a new version (hereinafter, referred to as new FW) will be described.

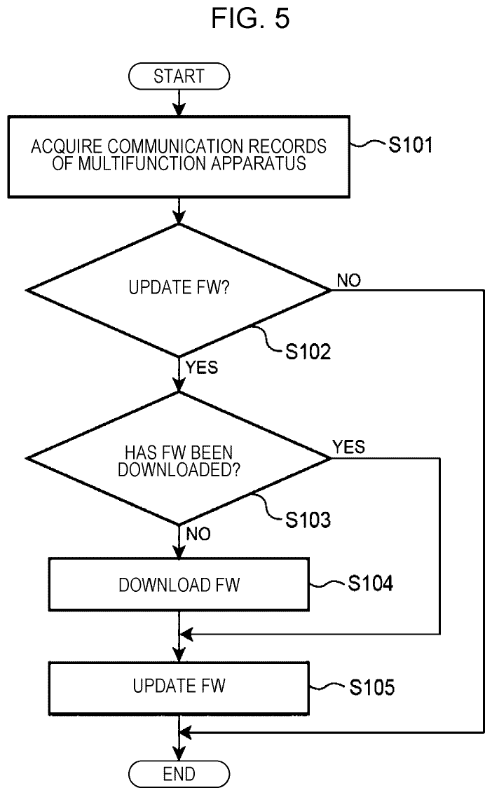

FIG. 5 is a flowchart illustrating an example of an update processing flow executed in the multifunction apparatus 18D. The flow is an example of an information processing method. The multifunction apparatus 18D is an example of a first apparatus. The old version is version 1.0.0 in FIG. 3, and the new version is version 2.0.0 in FIG. 3. The other multifunction apparatuses 18 (that is, the multifunction apparatuses 18A, 18B, and 18C) may perform the update processing in the same manner.

The present processing is performed when the CPU 21 of the multifunction apparatus 18D (hereinafter simply referred to as CPU 21) reads the information processing program from the ROM 22 or the storage 24 and executes the information processing program. In one example, the present processing starts when the CPU 21 receives, from the download server 16, storage information indicating that the new FW has been stored.

As illustrated in FIG. 5, when the present processing is started, the CPU 21 first acquires its own communication records (see FIG. 3) and the communication records (see FIG. 3) of the other multifunction apparatuses 18 (that is, the multifunction apparatuses 18A, 18B, and 18C) (step S101). Note that the other multifunction apparatuses 18 are examples of a second apparatus.

For example, the CPU 21 gives each of the other multifunction apparatuses 18 a transmission instruction to transmit communication records, and receives the communication records transmitted from each of the other multifunction apparatuses 18, thereby acquiring the communication records of the other multifunction apparatuses 18.

Note that when the communication records of the plurality of multifunction apparatuses 18 are stored in a place (for example, the management server 12) different from the respective storages 24, the CPU 21 acquires the communication records from the place.

Next, the CPU 21 executes determination processing to decide whether or not to execute the update of the FW based on the communication records between the server apparatus 14 and another multifunction apparatus 18 already provided with the new FW (step S102). The CPU 21 proceeds to step S103 in a case of determining to execute the update of the FW (step S102: YES), and the CPU 21 ends the present processing in a case of determining not to execute the update of the FW (step S102: NO). Specific processing of step S102 will be described later.

In step S103, the CPU 21 determines whether or not the new FW has been downloaded. When the CPU 21 determines in step S103 that the new FW has been downloaded (step S103: YES), the process proceeds to step S105. When the CPU 21 determines that the new FW has not been downloaded (step S103: NO), the process proceeds to step S104.

In step S104, the CPU 21 downloads the new FW from the download server 16 to the multifunction apparatus 18D (the storage 24). Next, in step S105, the CPU 21 performs update processing for activating the downloaded new FW in the multifunction apparatus 18D, and ends the present processing.

### Specific Processing in Step S102

In the present exemplary embodiment, the CPU 21 determines whether or not to execute the update of the FW based on, for example, a communication success rate in communication records of the new FW of other multifunction apparatuses 18 and a communication success rate in communication records of the old FW of other multifunction apparatuses 18. Specifically, when the communication success rate in the communication records of the new FW of other multifunction apparatuses 18 is equal to or higher than the communication success rate in the communication records of the old FW of other multifunction apparatuses 18, the CPU 21 determines to execute the update of the FW.

Here, the communication records of a communication protocol used by the multifunction apparatus 18D are used as the communication records being a basis for determination. That is, the communication records of the communication protocol included in the communication records of the multifunction apparatus 18D are used as the basis for determination.

According to the communication records of the multifunction apparatus 18D of the present exemplary embodiment, as illustrated in FIG. 3, the multifunction apparatus 18D uses a communication protocol “SMBv2”. Thus, communication records using the communication protocol “SMBv2”, among the communication records of the other multifunction apparatuses 18, are used as the basis for determination.

Further, a communication direction included in the communication records of the multifunction apparatus 18D and the communication records with a communication partner are used as the basis for determination. Since the communication records of the multifunction apparatus 18D include communication in a direction from the multifunction apparatus 18 to the server apparatus 14 and communication with the server apparatuses 14A and 14B being communication partners, these communication records are used as the basis for determination. Note that the communication protocol is an example of a communication protocol.

In the present exemplary embodiment, in FIG. 3, among the communication records of the other multifunction apparatuses 18 that satisfy the above-described conditions, there are three communication records indicated with a symbol XA as communication records of the new FW, and there are three communication records indicated with a symbol XB as communication records of the old FW.

The three communication records (XA) of the new FW are all communication success (communication success rate of 2/2). Of the three communication records (XB) of the old FW, two are communication success and one is communication failure (communication success rate of ⅔). As described above, in the example of FIG. 3, since the communication success rate in the communication records of the new FW of the other multifunction apparatuses 18 is equal to or higher than the communication success rate in the communication records of the old FW of other multifunction apparatuses 18, the CPU 21 determines to execute the update of the FW.

Note that the CPU 21 updates the FW to, for example, the latest version in a case that communication success rates are equal among a plurality of versions of the FW. For example, in the above-described example, in a case that all the communications with the old FW are successful and all the communications with the new FW are successful, the CPU 21 determines to update to the new FW.

Further, at the start of operation, for example, in a case that the multifunction apparatus 18 does not have communication records of its own or there are no communication records of the other multifunction apparatuses 18, the CPU 21 may be configured to update the FW to the new FW when the new FW is the latest version of the FW.

Furthermore, when there are multiple communication protocols used by the multifunction apparatus 18D, the CPU 21 may use communication records in a communication protocol with a high communication frequency or a high communication success rate among the communication records of the multifunction apparatus 18D as the basis for determination.

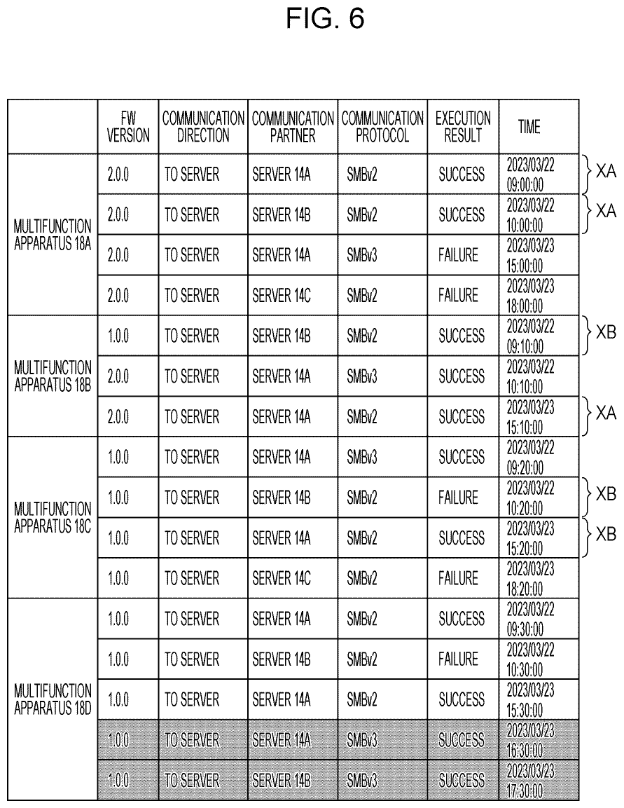

For example, in a case of the example illustrated in FIG. 6, the multifunction apparatus 18D uses “SMBv2” and “SMBv3” as the communication protocols, and the communication success rate of “SMBv3” is higher than that of “SMBv2”. In the case above, as the basis for determination, the communication records using the communication protocol “SMBv3” may be used in the communication records of the other multifunction apparatuses 18.

Further, in the example illustrated in FIG. 6, the communication frequency of “SMBv2” is higher than that of “SMBv3”. Accordingly, when the communication frequency is used as a criterion, communication records using the communication protocol “SMBv2” may be used as the basis for determination in the communication records of the other multifunction apparatuses 18. Note that in a case that there are a plurality of communication protocols used by the multifunction apparatus 18D, communication records in the plurality of communication protocols can be used as the basis for determination.

### Effects of Present Exemplary Embodiment

According to the present exemplary embodiment, the CPU 21 determines whether or not to execute the update in the multifunction apparatus 18D (step S102), when updating the firmware used to communicate with the server apparatus 14 in the multifunction apparatus 18D, based on communication records between another multifunction apparatus 18 already provided with the firmware and the server apparatus 14.

For this reason, when the CPU 21 updates the firmware in the multifunction apparatus 18D, the occurrence of a communication failure is suppressed when the multifunction apparatus 18D communicates with the server apparatus 14 using the firmware, compared with a case that the CPU 21 determines whether or not to execute the update in the multifunction apparatus 18D based on only the information regarding the version of the firmware.

Further, in the present exemplary embodiment, the CPU 21 determines whether or not to execute the update in the multifunction apparatus 18D (step S102) based on the communication records of the communication protocol used by the multifunction apparatus 18D among communication records of the other multifunction apparatuses 18.

For this reason, the occurrence of a communication failure is suppressed when the multifunction apparatus 18D communicates with the server apparatus 14 using the firmware, compared to a case that the CPU 21 determines whether or not to execute the update in the multifunction apparatus 18D based on all the communication records of the other multifunction apparatuses 18.

Further, in the present exemplary embodiment, when there are a plurality of communication protocols used by the multifunction apparatus 18D, the CPU 21 determines whether or not to execute the update in the multifunction apparatus 18D (step S102) based on communication records of a communication protocol with a high communication frequency or a high communication success rate, among communication records of the other multifunction apparatuses 18.

For this reason, the occurrence of a communication failure is suppressed when the multifunction apparatus 18D communicates with the server apparatus 14 using the firmware, compared with a case that the CPU 21 determines whether or not to execute the update in the multifunction apparatus 18D based on all the communication records of the communication protocols used by the multifunction apparatus 18D.

### First Modification of Processing in Step S102

The CPU 21 may determine whether or not to execute the update of the firmware in the multifunction apparatus 18D based on the communication records excluding the communication failure due to a communication error, among communication records of the other multifunction apparatuses 18.

The communication failure due to a communication error is a communication failure not caused by the FW and is a communication failure that occurs under a situation in which the FW normally operates without the communication error. Examples of the communication error include those due to incorrect authentication information (mismatch of credential information such as username/password or biometric data) and physical communication path disorder such as decoupling of a network cable.

According to the present modification, suppressed is the occurrence of a case in which the update of the firmware matching with the multifunction apparatus 18D is not executed, compared with a case that the CPU 21 determines whether or not to execute the update in the multifunction apparatus 18D based on all the communication records of the other multifunction apparatuses 18.

Further, in this modification, the CPU 21 may set a communication failure due to communication timeout as the communication failure due to a communication error and exclude such communication records from the communication records of the other multifunction apparatuses 18, and may determine whether or not to execute the update in the multifunction apparatus 18D based on the remaining communication records.

In this case, the processing is simplified compared to a case that the CPU 21 excludes communication records of the communication failure due to a communication error from communication records after identifying a specific cause of the communication failure.

### Second Modification of Processing in Step S102

The CPU 21 may determine whether or not to execute the update in the multifunction apparatus 18D based on the communication records of the multifunction apparatus 18 having similar past communication records to the past communication records of the multifunction apparatus 18D among the other multifunction apparatuses 18 (multifunction apparatuses 18A, 18B, and 18C).

According to the present modification, the occurrence of a communication failure is suppressed when the multifunction apparatus 18D communicates with the server apparatus 14 using the firmware, compared with a case that whether or not to execute the update in the multifunction apparatus 18D is determined based on all the communication records of the other multifunction apparatuses 18.

The CPU 21 can specify the multifunction apparatus 18 with the closest coincidence rate of success or failure in communication results under the same communication conditions, among the other multifunction apparatuses 18, as the multifunction apparatus 18 having the similar past communication records. Examples of the communication condition include the version of FW and the communication protocol. Further, the communication condition may include at least one of a communication partner and a communication direction. Note that the coincidence rate of success or failure may be determined based on not only the success rate of communication but also the failure rate of communication.

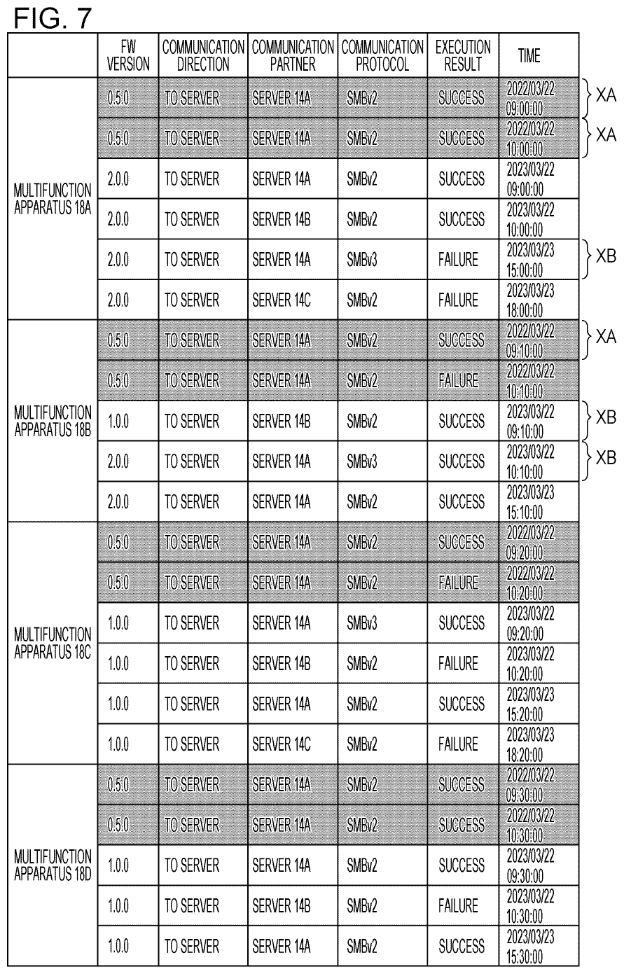

Specifically, for example, success or failure in communication records of the multifunction apparatus 18D with the FW of old version (0.5.0) and success or failure in communication records of the other multifunction apparatuses 18 with the FW of old version (0.5.0) are compared with each other, and the communication records of the multifunction apparatus 18 having the closest coincidence rate of success or failure can be used as the basis for determination. In an example illustrated in FIG. 7, in the communication records of the multifunction apparatus 18D with the FW of old version (0.5.0), both of two are successful (communication success rate of 2/2). In the communication records of the multifunction apparatuses 18B and 18C with the FW of old version (0.5.0), one is successful and the other is a failure (communication success rate of ½). In the communication records of the multifunction apparatus 18A with the FW of old version (0.5.0), both of two are successful (communication success rate of 2/2), same as the communication records of the multifunction apparatus 18D. In this case, whether or not to execute the update in the multifunction apparatus 18D is determined based on the communication records of the multifunction apparatus 18A.

As described above, identifying the multifunction apparatus 18 having similar past communication records makes it possible to identify the multifunction apparatus 18 uniquely.

### Modification of Update Processing Flow

In the update processing flow described above, as an example, the process starts when the CPU 21 receives storage information indicating that the new FW has been stored from the download server 16, that is, at the timing when the new FW is published, but the timing is not limited thereto.

The FW may be re-evaluated and updated to the FW of an optimum version at a predetermined timing. Examples of the timing include a timing at which the communication failure occurrence rate exceeds a criterion in communication with another apparatus such as the server apparatus 14. Thus, when a communication failure occurs after the FW is updated to the new FW, it is possible to change the FW to the old FW.

Further, as the timing, for example, the update processing flow may be executed at a timing at which the frequently used server apparatus 14 (frequency of use of each server apparatus 14) among the plurality of server apparatuses 14 is changed, or at a timing at which a predetermined period elapses.

Further, for example, the update processing flow may be executed in the multifunction apparatus 18D at the time of cloning from the multifunction apparatus 18A using the new FW to the multifunction apparatus 18D using the old FW. Note that the cloning is a process of copying parameters such as network settings and user data such as an address book to another apparatus (multifunction apparatus 18D in the example above).

Further, the processing for updating a function (specifically, FW) has been described in the present exemplary embodiment, but the case is not limited thereto. For example, even when the version down of the function is performed, the CPU 21 can execute the determination processing. That is, the CPU 21 can execute the above-described determination processing at a time of changing the function including update (version up) and version down. Further, the CPU 21 can execute the above-described determination processing when a function is newly added.

### Other Modifications

In the present exemplary embodiment, an example of the communication destination is the server apparatus 14, but the communication destination is not limited thereto. An example of the communication destination may be, for example, a terminal apparatus (personal computer, smartphone, or the like), a multifunction apparatus, or any other apparatus as long as the apparatus can communicate with another apparatus.

Further, in the present exemplary embodiment, an example of each of the first apparatus and the second apparatus is the multifunction apparatus 18, but each of the first apparatus and the second apparatus is not limited thereto. An example of each of the first apparatus and the second apparatus may be, for example, a terminal apparatus (personal computer, smartphone, or the like), a server apparatus, a facsimile, or any other apparatus as long as the apparatus can communicate with another apparatus. Furthermore, the example of the first apparatus and the example of the second apparatus may be different types of apparatuses.

Further, in the present exemplary embodiment, an example of the function used when communicating with a communication destination is the FW, but the function is not limited thereto. An example of the function may be, for example, an application, software, a program, a communication protocol, or the like, and the function only needs to be used in communication with a communication destination.

Further, in the present exemplary embodiment, the information processing system 10 is an example of an information processing system, but for example, the multifunction apparatus 18 may be regarded as an example of the information processing system.

Further, a device including a processor that executes the determination processing may be configured as an external apparatus (for example, the management server 12) that is present outside the multifunction apparatus 18. In this case, the external apparatus or a system including the external apparatus can be regarded as an example of the information processing system.

Further, in the above exemplary embodiment, the processor refers to a processor in a broad sense, and includes a general purpose processor (for example, the above-described CPU) and a dedicated processor (for example, GPU: Graphics Processing Unit, ASIC: Application Specific Integrated Circuit, FPGA: Field Programmable Gate Array, programmable logic device, and the like).

Further, the operation of the processor in the above-described exemplary embodiment may be performed not only by one processor but also by a plurality of processors existing at physically separated locations in cooperation with each other. Further, the order of respective operations of a processor is not limited only to the order described in the above exemplary embodiment, and may appropriately be changed.

Further, the information processing system according to the present exemplary embodiment is not limited to a system constituted of a plurality of apparatuses, and may be a system constituted of a single apparatus. That is, the “system” according to the present exemplary embodiment may be constituted of a plurality of apparatuses, or may be constituted of a single apparatus.

The present exemplary disclosure is not limited to the above-described exemplary embodiments, and various modifications, changes, and improvements can be made without departing from the spirit of the present exemplary disclosure. For example, the modifications described above may be combined in multiple as appropriate.

### APPENDIX

(((1)))

An information processing system comprising:
a processor configured to:
   determine whether or not to execute addition or change to a first apparatus, when making the addition or the change of a function used to communicate with a communication destination to the first apparatus, based on communication records between a second apparatus already provided with the function and the communication destination.
(((2)))

The information processing system according to (((1))), wherein the processor is configured to determine whether or not to execute the addition or the change to the first apparatus based on communication records of a communication protocol used by the first apparatus among the communication records.
(((3)))

The information processing system according to (((2))), wherein the processor is configured to determine whether or not to execute the addition or the change to the first apparatus based on communication records in a communication protocol having a high communication frequency or a high communication success rate among the communication records, in a case that there are a plurality of communication rules used by the first apparatus.
(((4)))

The information processing system according to any one of (((1))) to (((3))), wherein the processor is configured to determine whether or not to execute the addition or the change to the first apparatus based on communication records excluding a communication failure due to a communication error among the communication records.
(((5)))

The information processing system according to (((4))), wherein the processor is configured to determine whether or not to execute the addition or the change to the first apparatus based on communication records excluding a communication failure due to a communication timeout as the communication failure due to the communication error.
(((6)))

The information processing system according to any one of (((1) to (((5))), wherein the processor is configured to determine whether or not to execute the addition or the change to the first apparatus based on communication records of a second apparatus having similar past communication records to past communication records of the first apparatus among a plurality of the second apparatuses.
(((7)))

The information processing system according to (((6))), wherein the processor is configured to determine a second apparatus having a closest coincidence rate of success or failure in communication results under the same communication conditions, among the plurality of second apparatuses, as the second apparatus having the similar past communication records.
(((8)))

An information processing program causing a computer to execute a process for processing information, the process comprising:
determining whether or not to execute addition or change to a first apparatus, when making the addition or the change of a function to be used in communication with a communication destination to the first apparatus, based on communication records between a second apparatus already provided with the function and the communication destination.
(((9)))

An information processing method comprising:
determining whether or not to execute addition or change to a first apparatus, when making the addition or the change of a function to be used in communication with a communication destination to the first apparatus, based on communication records between a second apparatus already provided with the function and the communication destination.

What is claimed is:

1. An information processing system comprising:
a processor configured to:
determine whether or not to execute addition or change to a first apparatus, when making the addition or the change of a function used to communicate with a communication destination to the first apparatus, based on communication records between a second apparatus already provided with the function and the communication destination.

2. The information processing system according to claim 1, wherein the processor is configured to determine whether or not to execute the addition or the change to the first apparatus based on communication records of a communication protocol used by the first apparatus among the communication records.

3. The information processing system according to claim 2, wherein the processor is configured to determine whether or not to execute the addition or the change to the first apparatus based on communication records in a communication protocol having a high communication frequency or a high communication success rate among the communication records, in a case that there are a plurality of communication rules used by the first apparatus.

4. The information processing system according to claim 1, wherein the processor is configured to determine whether or not to execute the addition or the change to the first apparatus based on communication records excluding a communication failure due to a communication error among the communication records.

5. The information processing system according to claim 4, wherein the processor is configured to determine whether or not to execute the addition or the change to the first apparatus based on communication records excluding a communication failure due to a communication timeout as the communication failure due to the communication error.

6. The information processing system according to claim 1, wherein the processor is configured to determine whether or not to execute the addition or the change to the first apparatus based on communication records of a second apparatus having similar past communication records to past communication records of the first apparatus among a plurality of the second apparatuses.

7. The information processing system according to claim 6, wherein the processor is configured to determine a second apparatus having a closest coincidence rate of success or failure in communication results under the same communication conditions, among the plurality of second apparatuses, as the second apparatus having the similar past communication records.

8. A non-transitory computer readable medium storing a program causing a computer to execute a process for processing information, the process comprising:
determining whether or not to execute addition or change to a first apparatus, when making the addition or the change of a function to be used in communication with a communication destination to the first apparatus, based on communication records between a second apparatus already provided with the function and the communication destination.

9. An information processing method comprising:
determining whether or not to execute addition or change to a first apparatus, when making the addition or the change of a function to be used in communication with a communication destination to the first apparatus, based on communication records between a second apparatus already provided with the function and the communication destination.
